(19) United States
(12) Patent Application Publication
(10) Pub. No.: US 2026/0025019 A1
(43) Pub. Date: Jan. 22, 2026

(54) BACKPACK POWER SUPPLY COMMUNICATION

(71) Applicant: Milwaukee Electric Tool Corporation, Brookfield, WI (US)

(72) Inventors: Richard A. Behnke, Milwaukee, WI (US); Maxwell A. Casper, Menomonee Falls, WI (US); Tyler Graham, Brookfield, WI (US); Gavin DeGroot, Milwaukee, WI (US)

(21) Appl. No.: 19/264,507

(22) Filed: Jul. 9, 2025

Related U.S. Application Data
(60) Provisional application No. 63/671,859, filed on Jul. 16, 2024.
(60) Provisional application No. 63/677,120, filed on Jul. 30, 2024.

(51) Int. Cl. H02J 7/00; H01M 10/42; H01M 10/48; H01M 50/247

(52) U.S. Cl. CPC H02J 7/0063; H01M 10/425; H01M 10/488; H01M 50/247; H02J 7/00032; H02J 7/0047; H01M 2010/4278; H01M 2220/30

(57) ABSTRACT

A battery pack assembly configured to supply power to a common load includes a backpack wearable on a back of a user, at least one battery arranged in the backpack and electrically coupled to the common load via a tether, and a communications interface operable between the battery pack and the common load. The communications interface is configured to perform one or more operations, including but not limited to receiving and transmitting operational information to and from the battery pack and the common load, the operational information relating to at least one of the battery pack or the common load.

### CROSS-REFERENCE TO RELATED APPLICATIONS

This application is a non-provisional application claiming the benefit of priority under 35 U.S.C. § 119(e) to U.S. Provisional Application No. 63/671,859, filed on Jul. 16, 2024, and U.S. Provisional Application No. 63/677,120, filed on Jul. 30, 2024, which are hereby incorporated by reference in their entirety.

### FIELD

The present disclosure relates generally to handheld power tools, and more particularly to a communication interface for communicating between a battery pack having a plurality of batteries and a power tool.

### BACKGROUND

Portable battery-powered tools may rely on a rechargeable battery pack for power. The battery pack can connect directly to the tool (i.e., inserted into the tool) or may be configured as a self-contained unit that is carried by a user and electrically tethered to the tool, such as a backpack or carry-on battery pack. As the use and convenience of portable tools grows, so does the demand for increased power density and efficiency from these battery packs to provide more power and a longer run time for the tool.

The battery packs may be periodically charged in a compatible battery charger. These battery packs range in battery chemistry and nominal voltage and can be used to power numerous tools and electrical devices. In this regard, the use of lithium-ion (Li-ion) batteries in the battery packs has grown due in large part to the increased power density characteristics of these batteries. Multiple Li-ion batteries may be combined in parallel in the battery packs to increase the capacity of the packs even further. Moreover, the use of back-to-back MOSFETs connected in series between a Li-ion battery pack and the output load is a known configuration in conventional battery protection circuits. An integrated circuit (IC) controls the on/off state of the MOSFETs and the charge and discharge modes of the battery.

In certain instances, the battery packs are intended to work with only certain tools that use a common battery interface. However, such battery packs do not have a means for distinguishing between different types of power tools. For example, some battery packs include a series battery connection to achieve a higher voltage, yet the batteries therein remain isolated systems. The backpack supply must copy the isolated system to prevent potential Failure Mode and Effects Analysis (FMEA) and user error concerns. However, existing systems do not have a way to detect if the batteries are connected to a high side or a low side of the system.

### BRIEF DESCRIPTION

Aspects and advantages of the invention in accordance with the present disclosure will be set forth in part in the following description, or may be obvious from the description, or may be learned through practice of the technology.

In an aspect, the present disclosure is directed to a battery pack assembly configured to supply power to a common load. The battery pack assembly includes a backpack wearable on a back of a user, at least one battery arranged in the backpack and electrically coupled to the common load via a tether, and a communications interface operable between the battery pack and the common load. The communications interface is configured to perform one or more operations, including but not limited to receiving and transmitting operational information to and from the battery pack and the common load, the operational information relating to at least one of the battery pack or the common load.

In another aspect, the present disclosure is directed to a method of providing communication between a battery pack assembly and a power tool. The battery pack assembly is configured to supply power to the power tool. The method includes arranging a plurality of batteries in a backpack of the battery pack assembly, the backpack being wearable on a back of a user, electrically coupling the plurality of batteries to the power tool via a tether, communicatively coupling a communications interface between the battery pack and the power tool, and receiving and transmitting operational information to and from the battery pack and the power tool via the communications interface, the operational information relating to at least one of the battery pack or the power tool.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 illustrates a schematic view of an embodiment of a battery pack having a first battery and a second battery according to the present disclosure;

FIG. 2 illustrates a schematic view of an embodiment of a communications interface between a battery pack and a common load according to the present disclosure;

FIGS. 3A and 3B illustrate a configuration of a battery protection circuit that utilizes a back-to-back MOSFET;

FIG. 4 illustrates a schematic diagram of an embodiment of a system for supplying power to a common load according to the present disclosure; and

FIG. 5 illustrates a flow diagram of an embodiment of a method of providing communication between a battery pack assembly and a power tool according to the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counterclockwise.

As used herein, the term “power tool” is intended to refer to a device which is used to perform a work operation, such as trimming objects like branches; cutting materials like wood, metal, concrete, grass, or the like; biasing fluids like air and water; and the like. By way of non-limiting example, power tools can include hedge trimmers, chainsaws, circular saws, reciprocating saws, grinders, pruners, string trimmers, lawnmowers, edgers, blowers, vacuums, snow throwers, mixers, augers, pumps, pipe threaders, drills, and impact wrenches. While embodiments provided below are directed to hedge trimmers, one or more components of the hedge trimmer described below, such as the single-piece crankshaft, may be utilized with one or more different types of power tools.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

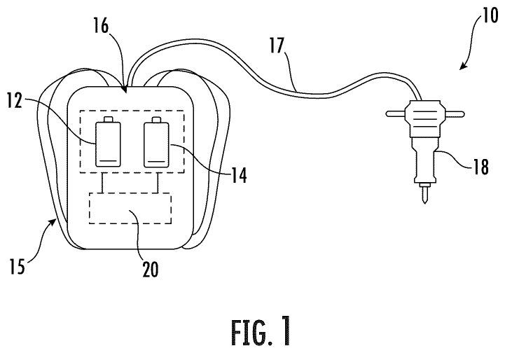

Referring now to FIG. 1, a battery pack assembly 10 having a battery pack 16 containing at least one battery 12, 14 arranged therein is illustrated. In particular, as shown, the battery pack 16 contains a first battery 12 and a second battery 14. Furthermore, in an embodiment, as shown, the batteries 12, 14 are electrically connected to a power tool 18 via an electrical tether 17 to supply power to the power tool 18. Moreover, in an embodiment, the battery pack 16 further contains a controller 20 for controlling one or more aspects of the battery pack assembly 10.

In addition, as shown, the battery pack 16 may contain one or more straps 15 that can be worn by a user, e.g., on his or her back, shoulder, or arm. It should be further understood that FIG. 1 merely depicts a known use of a battery pack assembly 10 and is not intended as a limitation of the invention. It should be appreciated that the battery pack assembly 10 incorporating aspects of the present invention can be configured with any embodiment wherein multiple batteries are provided in parallel to deliver power to a load, such as a power tool. Furthermore, the batteries 12, 14 are described herein as Li-ion batteries for ease of explanation only. The present disclosure is not limited to use with Li-ion batteries.

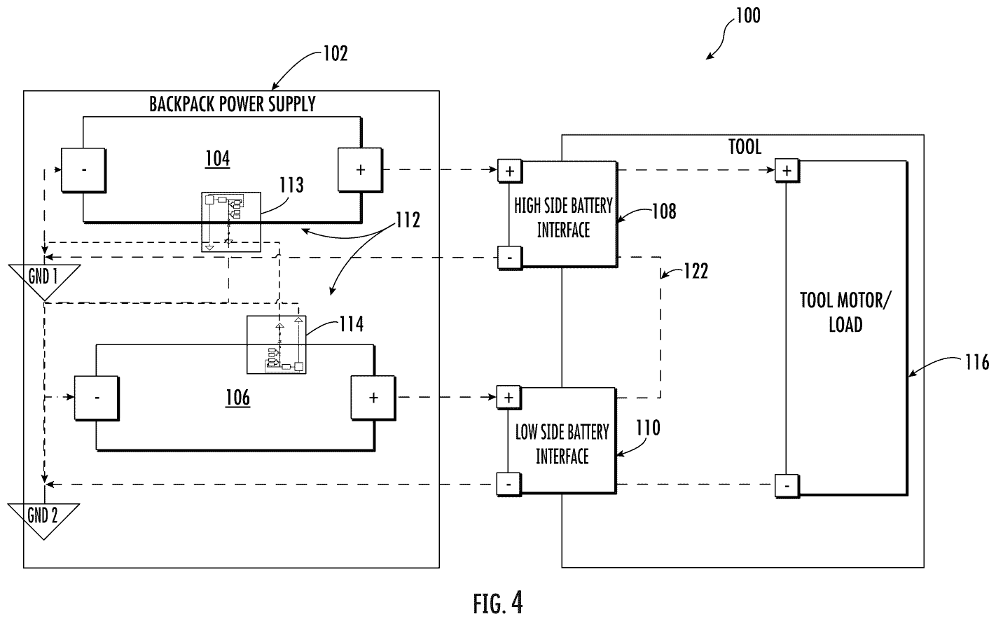

Referring now to FIG. 4, in an embodiment, the battery pack assembly 10 further includes a communications interface 19 operable between the battery pack 16 and the common load 18 (i.e., the power tool). The communications interface 19 is configured to perform one or more operations. For example, in an embodiment, such operations may include receiving and transmitting operational information 21 to and from the battery pack 16 and the common load 18. In such embodiments, the operational information 21 relates to the battery pack 16 and/or the common load 18.

Thus, in an embodiment, the common load 18 is configured to adjust a performance level thereof based on the operational information 21 from the communications interface 19. Furthermore, in an embodiment, the common load 18 is configured to determine the performance level based on an impedance of one or more of the batteries to prevent overtemperature conditions. In such embodiments, the performance level can be set by determining the impedance of the worst connected battery. Further, the performance level can be set based on knowledge of the common load 18 connected to the battery pack 16. Thus, in such embodiments, the performance level of the connected tool can be set to optimize the power output of the battery pack 16 and/or tool to reduce the risk of over-temping the batteries.

As used herein, the operational information can be any parameter relating to the battery pack and/or the common load 18. More specifically, in an embodiment, the operational information 21 may include an identification (ID) number of the battery pack 16, a total number of batteries installed in the battery pack 16, a request to operate relating to a type of the common load 18, a request for datalogger information, or one or more one-key settings. For example, the backpack ID and/or the number of installed batteries in the battery pack 16 may allow the power tool to decide if the performance level can be modified. Moreover, in an embodiment, the request to operate can allow the battery pack 16 to only work with certain power tools using a hardware lockout to prevent operation of single battery power tools. Further, in an embodiment, the power tool 18 can request that the battery pack 16 disengage the hardware lockout feature and operate with previously restricted tools. In another embodiment, the battery pack 16 and/or the power tool 18 can request the datalogger information and/or can share one key settings with the other.

Accordingly, in certain embodiments, the common load 18 is configured to send a request to operate to the battery pack 16 via the communications interface 19, whereas the battery pack 16 is configured to respond with an acknowledgement command via the communications interface 19. In another embodiment, the communications interface 19 is further configured to receive a start command, a stop command, or a continue command from the battery pack 16 and/or the common load 18.

In an embodiment, the communications interface 19 may use any suitable communications means to facilitate communications between the battery pack 16 and the common load 18. For example, in an embodiment, the communications interface 19 may include Bluetooth Low Energy (BLE) communication. In such embodiments, the battery pack 16 and the common load 18 may each include a pairing feature (e.g., first and second pairing features 25, 27, respectively) for pairing the BLE communications interface between the battery pack 16 and the common load 18.

In another embodiment, the communications interface 19 may include OpenLink® software communication across battery interface connections/terminals of the battery pack 16 with the battery chargers. In such embodiments, the DC/DP lines are inverted and the battery pack 16 and the common load 18 communicates using OpenLink®. Thus, in an embodiment, the battery pack 16 acts as the battery and provides information to the common load 18. Accordingly, communication occurs through the tether 17 and an adapter connection to the common load 18. As such, the common load 18 is configured to recognize the battery pack 16 when requesting information on what battery the common load is connected to. This knowledge can unlock further communications between the battery pack 16 and the common load 18. Thus, the battery pack 16 and the common load 18 can work together to optimize the performance of each other while leveraging existing battery terminal connections.

In further embodiments, the communications interface 19 may include Near Field Communication (NFC). In such embodiments, the NFC may include a first NFC circuit 28 on the battery pack 16 and a second NFC circuit 30 on the common load 18. Thus, in an embodiment, the first and second NFC circuits are configured to communicate with each other when a distance between the first and second NFC circuits is within a distance range. In still another embodiment, the communications interface 19 may include radio frequency identification (RFID) communication for communicating with the battery pack 16, e.g., with respect to what type of common load 18 is connected to the battery pack 16.

In additional embodiments, the communications interface 19 may also include one or more LEDs 23 for indicating a status of a connection between the battery pack 16 and the common load 18.

In additional embodiments, as mentioned, the battery pack 16 may include the high side battery interface 108 and the low side battery interface 110. In such embodiments, the communications interface 19 is configured to level shift a signal from the high side battery interface 108 to a voltage level for the controller 20 of the battery pack 16, such that the controller 20 can read the signal at frequencies of up to 10 kilohertz (kHz).

In further embodiments, the common load 18 is configured to utilize the communications interface 19 to communicate with the battery pack 16 to optimize a discharge control algorithm of the battery pack 16. In an embodiment, for example, the battery pack 16 can swap between multiple batteries to provide a source of power, which the discharge control algorithm being designed to provide the optimal end user experience. More specifically, in an embodiment, voltage based switching can be used to provide a consistent output power by swapping between batteries every set amount of time and discharge from the optimal battery. In another embodiment, at trigger pull of the power tool 18, the optimal battery can be determined and the battery pack 16 can use that battery for the duration of the application (while current is being pulled from the battery pack 16). In yet another embodiment, the battery pack 16 can start the battery 12 and then discharge the battery 12 entirely before swapping to battery 14. Furthermore, in an embodiment, the common load 18 can communicate with the battery pack 16 its preferred discharge control algorithm. As such, the discharge control algorithm can be optimized to provide the end user the best experience based on the application.

In such embodiments, as an example, the discharge control algorithm is configured to determine an optimal battery within the battery pack 16 for providing power to the common load 18 based on battery information transmitted by the communications interface 19. In such embodiments, the battery information may include voltage, impedance, battery series, a number of parallel cells, temperature, and/or any other suitable condition.

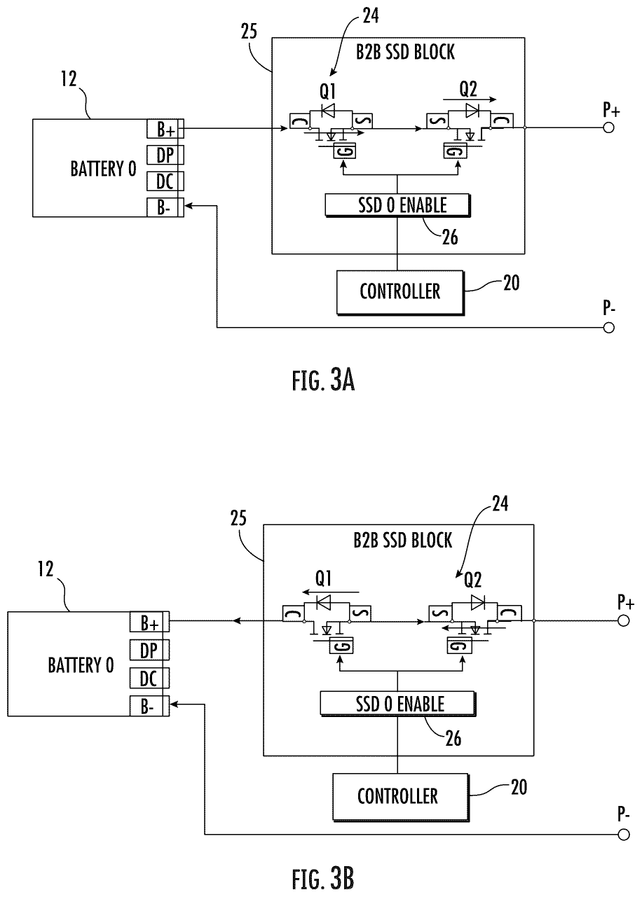

Referring now to FIGS. 3A and 3B, schematic diagrams of a battery protection circuit that utilizes a back-to-back MOSFET structure are illustrated. More specifically, as shown, the back-to-back MOSFET structure includes two power MOSFETs 24 and a driver 26 implemented with a solid state drive (SSD) within the controller 20 or otherwise in communication with the controller 20. Moreover, as shown, the MOSFETs 24 are connected in series between the Li-ion battery 12 and the output load. The controller 20 may be a dedicated IC (integrated circuit) used to control gating (i.e., the on and off states) of the MOSFETs 24 for managing the charge and discharge modes of the battery 12. One of the MOSFETs 24 (e.g., Q1) is used for discharging the battery 12 to supply power to the load (FIG. 3A) and the other MOSFET 24 (e.g., Q2) is used for charging (FIG. 3B) the battery 12. The MOSFETs 24 are depicted at the positive (“high-end”) of the battery 12. In other embodiments, the MOSFETs 24 may be located at the negative (“low-end”) of the battery 12. The MOSFETs 24 may be P-channel or N-channel MOSFETs, with the sources connected in a back-to-back structure known as common source configuration, as depicted in FIGS. 3A and 3B.

In the discharge mode of the battery 12 depicted in FIG. 3A, the controller 20 provides the gate drive signal to the driver 26 to drive the discharge MOSFET Q1 to the high (on) state. When Q1 is on, the discharge path (indicated by the arrows in FIG. 3A) is through Q1, across the parasitic diode around Q2, and to the load. In a certain embodiment, the controller 20 may also turn on Q2 (which has a lower resistance than the parasitic diode around Q2) in order to avoid the conduction loss (voltage drop) from the parasitic diode.

In the charging mode of the battery 12 depicted in FIG. 3B, the controller 20 provides the gate drive signal to the driver 26 to drive the charging MOSFET Q2 to the high (on) state. When Q2 is on, the charging path (indicated by the arrows in FIG. 3B) is through Q2, across the parasitic diode around Q1, and to the battery 12. In a certain embodiment, the controller 20 may also turn on Q1 (which has a lower resistance than the parasitic diode around Q1) in order to avoid the avoid the conduction loss (voltage drop) from the parasitic diode.

Referring now to FIG. 4, a schematic diagram of an embodiment of a system 100 for supplying power to a common load 116 according to the present disclosure is illustrated. For example, in an embodiment, the common load 116 may be the power tool 18 of FIG. 1, or any suitable handheld power tool. More specifically, as shown, the system 100 includes a battery pack assembly 102 having at least one battery 104, 106 connected to the common load 116 via a high side battery interface 108 and a low side battery interface 110. For example, as shown, the battery pack assembly 102 includes a first battery 104 and a second battery 106 that are together electrically coupled to the common load 116 via the high side battery interface 108 and the low side battery interface 110.

In addition, as shown, the battery pack assembly 102 further includes at least voltage detection circuit assembly 112 electrically coupled to each of the batteries 104, 106. Moreover, in an embodiment, as shown in FIG. 4, each voltage detection circuit assembly 112 includes a first circuit 113 and a second circuit 114. Further, as shown in the illustrated embodiment of FIG. 4, the first battery 104 is connected to a positive side (+) of the high side battery interface 108 and the second battery 106 is connected to a positive side (+) of the low side battery interface 110. Moreover, in the illustrated embodiment, V_{GND2} is less than V_{GND1}. In such embodiments, the difference in the reference voltage is driven by a tool side series connection 122 that connects the otherwise isolated modules (e.g., the first and second batteries 104, 106). By referencing the isolated voltage detection circuit assembly 112 to both the other modules (e.g., the first and second batteries 104, 106) B-voltage (e.g., the corresponding GND(X)), the voltage detection circuit assembly 112 can be an automatically triggered circuit that only trips in the presence of a stacked battery voltage.

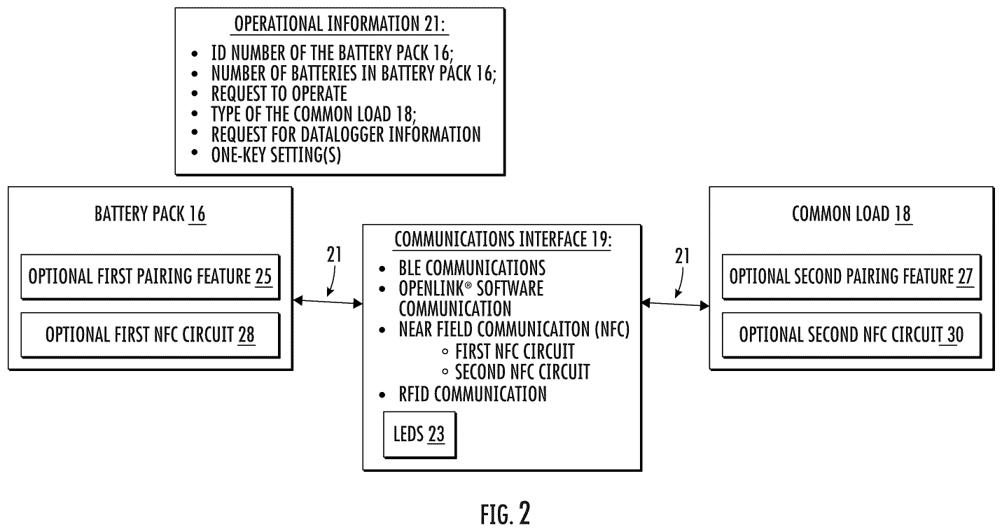

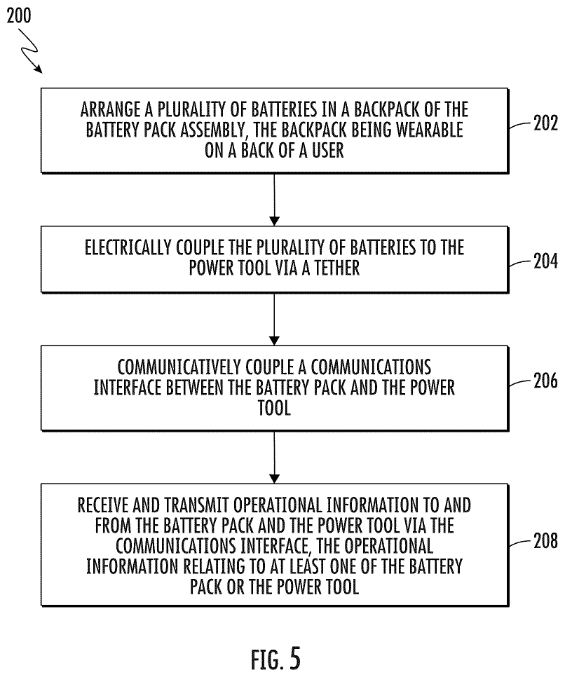

Referring now to FIG. 5, a flow diagram of an embodiment of a method 200 of providing communication between a battery pack assembly and a power tool according to the present disclosure. Such a method 200, for example, may be implemented by the battery pack assembly 102 of FIGS. 1-2. Further, the method 200 is illustrated as a collection of blocks in a logical flow chart, which represents operations that may be implemented in hardware, software, or combinations thereof. The order in which the method 200 is described is not intended to be construed as a limitation, and any number of the described blocks may be combined in any order to implement the exemplary method disclosed herein, or an equivalent alternative method. Additionally, certain blocks may be deleted from the exemplary method or augmented by additional blocks with added functionality without departing from the spirit and scope of the subject matter described herein.

As shown at (202), the method 200 includes arranging a plurality of batteries in a backpack of the battery pack assembly, the backpack being wearable on a back of a user. As shown at (204), the method 200 includes electrically coupling the plurality of batteries to the power tool via a tether. As shown at (206), the method 200 includes communicatively coupling a communications interface between the battery pack and the power tool. As shown at (208), the method 200 includes receiving and transmitting operational information to and from the battery pack and the power tool via the communications interface, the operational information relating to at least one of the battery pack or the power tool.

Further aspects of the invention are provided by one or more of the following clauses:

A battery pack assembly configured to supply power to a common load, the battery pack assembly comprising: a backpack wearable on a back of a user; at least one battery arranged in the backpack and electrically coupled to the common load via a tether; and a communications interface operable between the battery pack and the common load, the communications interface configured to perform one or more operations, the one or more operations comprising: receiving and transmitting operational information to and from the battery pack and the common load, the operational information relating to at least one of the battery pack or the common load.

The battery pack assembly of any preceding clause, wherein the operational information comprises at least one of an identification number of the battery pack, a total number of batteries installed in the battery pack, a request to operate relating to a type of the common load, a request for datalogger information, or one or more one-key settings.

The battery pack assembly of any preceding clause, wherein the communications interface is further configured to receive at least one of a start command, a stop command, or a continue command from at least one of the battery pack or the common load.

The battery pack assembly of any preceding clause, wherein the communications interface comprises a Bluetooth Low Energy (BLE) communications interface.

The battery pack assembly of any preceding clause, wherein the battery pack and the common load each comprise a pairing feature for pairing the BLE communications interface between the battery pack and the common load.

The battery pack assembly of any preceding clause, wherein the communications interface comprises OpenLink® software communication across battery interface connections of the battery pack.

The battery pack assembly of any preceding clause, wherein the communications interface comprises Near Field Communication (NFC).

The battery pack assembly of any preceding clause, wherein the NFC comprises a first NFC circuit on the battery pack and a second NFC circuit on the common load, and wherein the first and second NFC circuits communicate with each other when a distance between the first and second NFC circuits is within a distance range.

The battery pack assembly of any preceding clause, wherein the communications interface comprises radio frequency identification (RFID) communication for communicating with the battery pack what type of common load is connected to the battery pack.

The battery pack assembly of any preceding clause, further comprising one or more LEDs for indicating a status of a connection between the battery pack and the common load.

The battery pack assembly of any preceding clause, wherein the common load sends a request to operate to the battery pack via the communications interface and the battery pack responds with an acknowledgement command via the communications interface.

The battery pack assembly of any preceding clause, wherein the common load is configured to adjust a performance level thereof based on the operational information from the communications interface.

The battery pack assembly of any preceding clause, wherein the common load is configured to determine the performance level based on an impedance of the at least one battery to prevent overtemperature conditions.

The battery pack assembly of any preceding clause, wherein the battery pack comprises a high side battery and a low side battery, and wherein the communications interface is configured to level shift a signal from the high side battery to a voltage level for a processor of the battery pack, such that the processor can read the signal at frequencies of up to 10 kilohertz (kHz).

The battery pack assembly of any preceding clause, wherein the common load utilizes the communications interface to communicate with the battery pack to optimize a discharge control algorithm of the battery pack, the battery pack comprises a plurality of batteries.

The battery pack assembly of any preceding clause, wherein the discharge control algorithm determines an optimal battery of the plurality of batteries for providing power to the common load based on battery information transmitted by the communications interface, the battery information comprising at least one of voltage, impedance, battery series, a number of parallel cells, or temperature.

The battery pack assembly of any preceding clause, wherein the common load is a power tool.

A method of providing communication between a battery pack assembly and a power tool, the battery pack assembly configured to supply power to the power tool, the method comprising: arranging a plurality of batteries in a backpack of the battery pack assembly, the backpack being wearable on a back of a user; electrically coupling the plurality of batteries to the power tool via a tether; communicatively coupling a communications interface between the battery pack and the power tool; and receiving and transmitting operational information to and from the battery pack and the power tool via the communications interface, the operational information relating to at least one of the battery pack or the power tool.

The method of any preceding clause, wherein the operational information comprises at least one of an identification number of the battery pack, a total number of batteries installed in the battery pack, a request to operate relating to a type of the power tool, a request for datalogger information, or one or more one-key settings.

The method of any preceding clause, wherein the communications interface comprises at least one of Bluetooth Low Energy (BLE) communication, OpenLink® software communication across battery interface connections of the battery pack, Near Field Communication (NFC), or radio frequency identification (RFID) communication.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A battery pack assembly configured to supply power to a common load, the battery pack assembly comprising:
a backpack wearable on a back of a user;
at least one battery arranged in the backpack and electrically coupled to the common load via a tether; and
a communications interface operable between the battery pack and the common load, the communications interface configured to perform one or more operations, the one or more operations comprising:
receiving and transmitting operational information to and from the battery pack and the common load, the operational information relating to at least one of the battery pack or the common load.

2. The battery pack assembly of claim 1, wherein the operational information comprises at least one of an identification number of the battery pack, a total number of batteries installed in the battery pack, a request to operate relating to a type of the common load, a request for datalogger information, or one or more one-key settings.

3. The battery pack assembly of claim 1, wherein the communications interface is further configured to receive at least one of a start command, a stop command, or a continue command from at least one of the battery pack or the common load.

4. The battery pack assembly of claim 1, wherein the communications interface comprises a Bluetooth Low Energy (BLE) communications interface.

5. The battery pack assembly of claim 4, wherein the battery pack and the common load each comprise a pairing feature for pairing the BLE communications interface between the battery pack and the common load.

6. The battery pack assembly of claim 1, wherein the communications interface comprises OpenLink® software communication across battery interface connections of the battery pack.

7. The battery pack assembly of claim 1, wherein the communications interface comprises Near Field Communication (NFC).

8. The battery pack assembly of claim 7, wherein the NFC comprises a first NFC circuit on the battery pack and a second NFC circuit on the common load, and wherein the first and second NFC circuits communicate with each other when a distance between the first and second NFC circuits is within a distance range.

9. The battery pack assembly of claim 1, wherein the communications interface comprises radio frequency identification (RFID) communication for communicating with the battery pack what type of common load is connected to the battery pack.

10. The battery pack assembly of claim 1, further comprising one or more LEDs for indicating a status of a connection between the battery pack and the common load.

11. The battery pack assembly of claim 1, wherein the common load sends a request to operate to the battery pack via the communications interface and the battery pack responds with an acknowledgement command via the communications interface.

12. The battery pack assembly of claim 1, wherein the common load is configured to adjust a performance level thereof based on the operational information from the communications interface.

13. The battery pack assembly of claim 12, wherein the common load is configured to determine the performance level based on an impedance of the at least one battery to prevent overtemperature conditions.

14. The battery pack assembly of claim 1, wherein the battery pack comprises a high side battery and a low side battery, and wherein the communications interface is configured to level shift a signal from the high side battery to a voltage level for a processor of the battery pack, such that the processor can read the signal at frequencies of up to 10 kilohertz (kHz).

15. The battery pack assembly of claim 1, wherein the common load utilizes the communications interface to communicate with the battery pack to optimize a discharge control algorithm of the battery pack, the battery pack comprises a plurality of batteries.

16. The battery pack assembly of claim 15, wherein the discharge control algorithm determines an optimal battery of the plurality of batteries for providing power to the common load based on battery information transmitted by the communications interface, the battery information comprising at least one of voltage, impedance, battery series, a number of parallel cells, or temperature.

17. The battery pack assembly of claim 1, wherein the common load is a power tool.

18. A method of providing communication between a battery pack assembly and a power tool, the battery pack assembly configured to supply power to the power tool, the method comprising:
arranging a plurality of batteries in a backpack of the battery pack assembly, the backpack being wearable on a back of a user;
electrically coupling the plurality of batteries to the power tool via a tether;
communicatively coupling a communications interface between the battery pack and the power tool; and
receiving and transmitting operational information to and from the battery pack and the power tool via the communications interface, the operational information relating to at least one of the battery pack or the power tool.

19. The method of claim 18, wherein the operational information comprises at least one of an identification number of the battery pack, a total number of batteries installed in the battery pack, a request to operate relating to a type of the power tool, a request for datalogger information, or one or more one-key settings.

20. The method of claim 18, wherein the communications interface comprises at least one of Bluetooth Low Energy (BLE) communication, OpenLink® software communication across battery interface connections of the battery pack, Near Field Communication (NFC), or radio frequency identification (RFID) communication.
